(19) United States
(12) Patent Application Publication
(10) Pub. No.: US 2025/0216820 A1
(43) Pub. Date: Jul. 3, 2025

(54) MOTOR CONTROL APPARATUS, MOTOR CONTROL METHOD, AND STORAGE MEDIUM

(71) Applicant: KABUSHIKI KAISHA YASKAWA DENKI, Fukuoka (JP)

(72) Inventors: Tetsuya ASAI, Fukuoka (JP); Minoru KOGA, Fukuoka (JP); Kazuhide TAKAO, Fukuoka (JP)

(21) Appl. No.: 19/001,710

(22) Filed: Dec. 26, 2024

(30) Foreign Application Priority Data
Dec. 28, 2023 (JP) 2023-222882

(51) Int. Cl. G05B 13/04

(52) U.S. Cl. CPC G05B 13/041

(57) ABSTRACT

A motor control apparatus includes a model following control unit that computes a first control target value by calculating an equation that models a device including a motor based on an input position command value, an additional feedforward control unit that computes a second control target value based on differentiation of the input position command value, a synthesis unit that generates a synthesized control target value based on the first control target value and the second control target value, and a drive control unit that controls driving of the motor based on the synthesized control target value.

### CROSS-REFERENCE TO RELATED APPLICATIONS

This application is based on and claims priority from Japanese Patent Application No. 2023-222882 filed on Dec. 28, 2023, with the Japan Patent Office, the disclosure of which is incorporated herein in its entirety by reference.

### TECHNICAL FIELD

The present disclosure relates to a motor control apparatus, a motor control method, and a storage medium.

### BACKGROUND

Japanese Patent Laid-Open Publication No. 2018-151889 discloses a technique to enhance followability by using a so-called model following control based on a control model that models a control target.

### SUMMARY

Due to limitations in the accuracy of modeling the control target, delays may occur in commands to a motor, which is the control target. As a result, issues such as so-called overshoot may occur.

The present disclosure provides a motor control apparatus, a motor control method, and a storage medium having stored therein a program, which improve response performance.

According to one aspect of the present disclosure, a motor control apparatus includes a first computation unit that computes a first control target value by calculating an equation that models a device including a motor based on an input position command value, a second computation unit that computes a second control target value based on differentiation of the input position command value, a synthesis unit that generates a synthesized control target value based on the first control target value and the second control target value, and a drive control unit that controls driving of the motor based on the synthesized control target value.

According to the present disclosure, it is possible to provide a motor control apparatus, motor control method, and a storage medium having stored therein a program, which improve response performance.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram illustrating an example of an overall configuration of a motor control apparatus.

FIG. 2A is a graph illustrating the response performance of a motor control apparatus according to a conventional example.

FIG. 2B is a graph illustrating the response performance of a motor control apparatus according to the present embodiment.

FIG. 3A is a flowchart illustrating a processing executed in a drive control unit.

FIG. 3B is a flowchart illustrating a processing executed in a model following control unit and an additional feedforward control unit.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made without departing from the spirit or scope of the subject matter presented here.

### [Outline of Motor Control Apparatus]

In conventional model following control, as described above, the accuracy of modeling a control target may be insufficient, resulting in so-called overshoot. Therefore, a motor control apparatus 1 according to the present embodiment adopts a configuration that improves response performance by adding corrections based on additional feedforward control to model following control.

In addition, a position detection sensor such as an encoder (not illustrated) may be attached to a motor M, allowing a detected position (current rotational position) of the motor M to be acquired by the position detection sensor. Further, a detected speed (current rotational speed) may also be acquired based on a change in the detected position (first-order derivative). Then, in the motor control apparatus 1, drive control using a feedback loop is performed to approach a target position while determining whether the detected position of the motor M has rotated to a target rotational position.

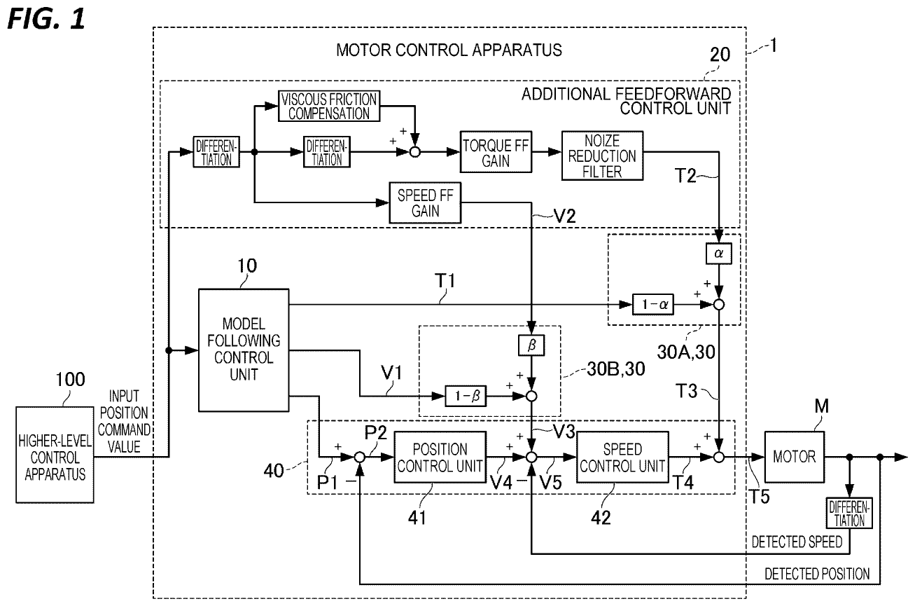

FIG. 1 is a diagram illustrating an example of an overall configuration of a motor control apparatus according to the present embodiment. As illustrated in FIG. 1, the motor control apparatus 1 includes a model following control unit 10, which is a first computation unit, an additional feedforward control unit 20, which is a second computation unit, a synthesis unit 30, and a drive control unit 40.

The motor control apparatus 1 may be composed of one or multiple computers. The motor control apparatus 1 includes at least one processor, at least one of a volatile memory or a nonvolatile memory, and a communication interface for wired or wireless communication. The model following control unit 10, additional feedforward control unit 20, synthesis unit 30, and drive control unit 40 may be implemented by the processor of the motor control apparatus 1. In addition, a program stored in the motor control apparatus 1 may be supplied via a network. For example, a reader (e.g., a memory card slot) for reading a computer-readable information storage medium or an input/output unit (e.g., a USB terminal) for connection to an external device may be included. In this case, a program stored in the information storage medium may be supplied through the reader or the input/output unit.

The motor control apparatus 1 controls the driving of the motor M, which is a control target, based on a command from a higher-level control apparatus 100. Specifically, an input position command value from the higher-level control apparatus 100 is input to each of the model following control unit 10 and the additional feedforward control unit 20, and the drive control unit 40 controls the driving of the motor M based on outputs from each of these control units. The motor M may be, for example, a servo motor. The higher-level control apparatus 100 may be configured with, for example, a general-purpose personal computer, a Programmable Logic Controller (PLC), a motion controller, and the like.

### [Model Following Control Unit]

The model following control unit 10 calculates an equation that models a device including the motor M (hereinafter referred to as “model equation”) based on the input position command value received from the higher-level control apparatus 100, thereby outputting first control target values, i.e., a first torque control target value T1, a first speed control target value V1, and a position control target value P1. The device that is a modeling target in the model equation may include one or more devices used to drive the motor M, and for example, may include the motor M, a position controller, and a speed controller. The model equation may be generated in advance based on the mechanical characteristics of the motor M such as the moment of inertia.

### [Additional Feedforward Control Unit]

The additional feedforward control unit 20 outputs second control target values, i.e., a second torque control target value T2 and a second speed control target value V2, based on the input position command value received from the higher-level control apparatus 100.

Specifically, the additional feedforward control unit 20 adds a viscous friction compensation value, which is calculated by multiplying a first-order derivative of the input position command value by a predetermined viscous friction coefficient, to a second-order derivative of the input position command value. Furthermore, the additional feedforward control unit 20 multiplies a torque feedforward gain by a value obtained by adding the viscous friction compensation value to the second-order derivative, and performs filtering using a noise reduction filter to output the second torque control target value T2. The predetermined viscous friction coefficient may be set in advance based on the performance of the motor M, the environment in which the motor M is used, and other factors.

Further, the additional feedforward control unit 20 outputs the second speed control target value V2 by multiplying the first-order derivative of the input position command value by a speed feedforward gain.

### [Synthesis Unit]

The synthesis unit 30 includes a torque control target value synthesis unit 30A and a speed control target value synthesis unit 30B.

The torque control target value synthesis unit 30A generates a synthesized torque control target value T3, which is a synthesized control target value by synthesizing the first torque control target value T1 and the second torque control target value T2 at a given ratio. When the given ratio is 1−α:α, for example, a may be set to 0.1. In this case, the proportion of the first torque control target value T1 is 90%, and the proportion of the second torque control target value T2 is 10%.

The speed control target value synthesis unit 30B generates a synthesized speed control target value V3, which is a synthesized control target value by synthesizing the first speed control target value V1 and the second speed control target value V2 at a given ratio. When the given ratio is 1−β:β, for example, β may be set to 0.1. In this case, the proportion of the first speed control target value V1 is 90%, and the proportion of the second speed control target value V2 is 10%.

In addition, the ratios α and β may be preset by user operation. For example, the overshoot amount may be acquired by actually driving the motor M, and the ratios may be appropriately set to reduce the overshoot amount. In addition, the ratios α and β may be greater than or equal to 0 and less than or equal to 1. Therefore, for example, the ratio α may be set to zero. In this case, the proportion of the first torque control target value T1 is 100%, and the proportion of the second torque control target value T2 is 0%. Similarly, the ratio β may also be set to zero. Further, the ratios α and β may also differ from each other.

Further, the synthesized torque control target value T3 may be a value generated based on the first torque control target value T1 and the second torque control target value T2, and is not limited to being generated by synthesizing them at a given ratio. For example, the ratio α is not preset but may vary depending on the detected speed or other factors. The same applies to the synthesized speed control target value V3.

### [Drive Control Unit]

The drive control unit 40 includes a position control unit 41 and a speed control unit 42. The position control unit 41 outputs a speed command V4 based on a position deviation P2, which is the difference between a current rotational position acquired by a position detection sensor (not illustrated) and the position control target value P1. The position control unit 41 may include, for example, an integrator that calculates an integral of the position deviation P2 to be added to the position deviation P2, and may be configured to perform a so-called PI control where the position deviation P2 is added to an output of the integrator and then multiplied by a position control gain.

The speed control unit 42 outputs a torque command T4 based on a speed deviation V5, which is the difference between a current detected speed based on a first-order derivative of the current rotational position detected by the position detection sensor and a corrected target speed obtained by correcting the synthesized speed control target value V3 by the speed command V4. The speed control unit 42 may include, for example, an integrator that calculates an integral of the speed deviation V5 to be added to the speed deviation V5, and may be configured to perform a so-called PI control where the speed deviation V5 is added to an output of the integrator and then multiplied by a speed control gain.

Furthermore, the drive control unit 40 generates a torque command correction value T5 based on the torque command T4 and the synthesized torque control target value T3. The torque command correction value T5 may be converted into a drive current value and input to the motor M.

Here, the position control target value P1, computed by the model following control unit 10, is a value related to the rotational position of the motor M, as predicted based on the input position command value from the higher-level control apparatus 100. Further, the synthesized speed control target value V3, generated by the speed control target value synthesis unit 30B, is a value related to the rotational speed of the motor M, as predicted based on the input position command value from the higher-level control apparatus 100. Further, the synthesized torque control target value T3, generated by the torque control target value synthesis unit 30A, is a value related to the torque of the motor M, as predicted based on the input position command value from the higher-level control apparatus 100.

There are cases where the position control target value P1, the synthesized speed control target value V3, and the synthesized torque control target value T3 deviate from the actual behavior of the motor M due to various factors such as external disturbances. Therefore, as described above, the drive control unit 40 outputs the speed command V4 based on the position deviation P2, which is the difference between the position control target value P1 and the current detected position, and corrects the synthesized speed control target value V3 by the speed command V4. Further, the drive control unit 40 outputs the torque command T4 based on the speed deviation V5, which is the difference between the current detected speed and the corrected target speed obtained by correcting the synthesized speed control target value V3 by the speed command V4, and corrects the synthesized torque control target value T3 by the torque command T4, thereby generating the torque command correction value T5. In this way, the drive control unit 40 controls the driving of the motor M to reduce the deviation between target values (predicted values) and the actual behavior of the motor M.

### [Response Performance of Motor Control Apparatus According to Present Embodiment]

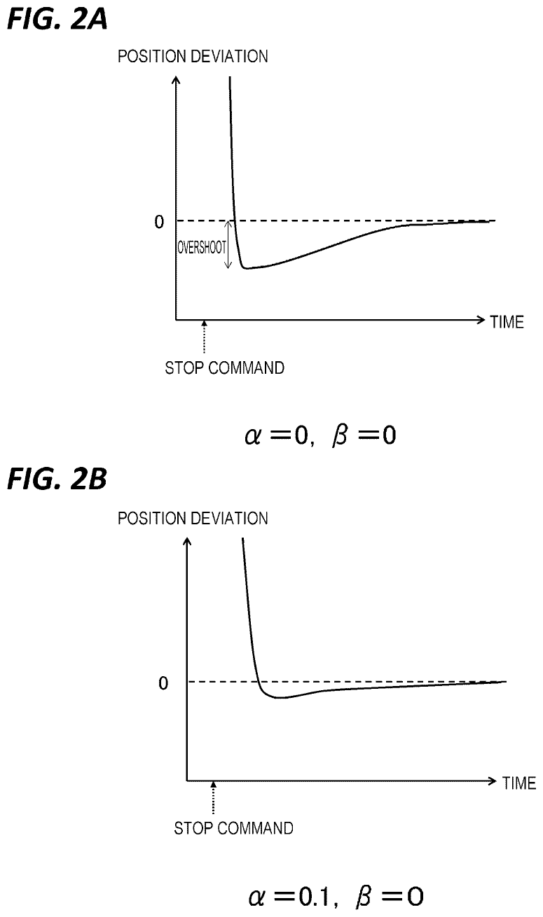

FIG. 2A is a graph illustrating the response performance of a motor control apparatus according to a conventional example. FIG. 2B is a graph illustrating the response performance of a motor control apparatus according to the present embodiment. In FIG. 2A, a case where α=0 and β=0, i.e., the behavior of a motor by a conventional motor control apparatus that performs only model following control without the additional feedforward control unit 20 is illustrated. In FIG. 2B, a case where α=0.1 and β=0, i.e., the behavior of the motor M when the motor control apparatus 1 according to the present embodiment performs drive control based on the synthesized torque control target value T3 where the proportion of the first torque control target value T1 is 90% and the proportion of the second torque control target value T2 is 10% is illustrated. FIGS. 2A and 2B illustrate examples in which a drive stop command is issued to the motor M.

As illustrated in FIG. 2A, in conventional motor control apparatus, a significant overshoot occurs after the stop command, and time is required until the position deviation converges to zero. In contrast, as illustrated in FIG. 2B, in the motor control apparatus 1 according to the present embodiment, it can be seen that the overshoot is smaller and the position deviation approaches zero relatively quickly, compared to the example illustrated in FIG. 2A. This indicates an improvement in response performance.

### [Flowchart]

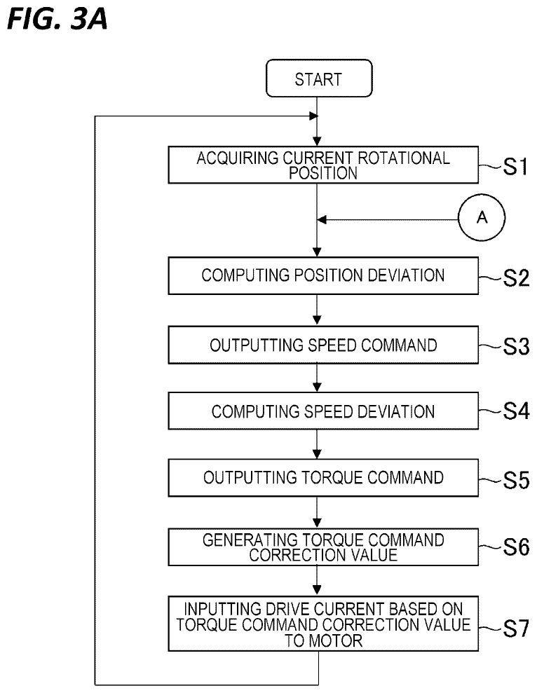

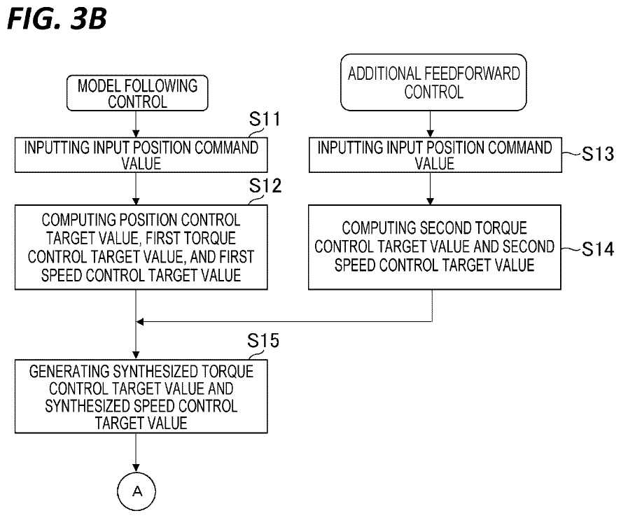

Next, an example of processing executed in the motor control apparatus 1 will be described with reference to FIGS. 3A and 3B. FIG. 3A is a flowchart illustrating a processing executed in the drive control unit. FIG. 3B is a flowchart illustrating a processing executed in the model following controller and the additional feedforward control unit. The processing illustrated in FIGS. 3A and 3B is executed by the processor of the motor control apparatus 1 executing a control program stored in the memory.

First, the drive control unit 40 acquires a current rotational position of the motor M (S1).

Here, as illustrated in FIG. 3B, an input position command value is input from the higher-level control apparatus 100 to the model following control unit 10 and the additional feedforward control unit 20 (S11 and S13). The model following control unit 10 computes the position control target value P1, the first torque control target value T1, and the first speed control target value V1 based on the input position command value (S12). The additional feedforward control unit 20 computes the second torque control target value T2 and the second speed control target value V2 based on the input position command value (S14).

Furthermore, the synthesis unit 30 generates the synthesized torque control target value T3 based on the first torque control target value T1 and the second torque control target value T2, and generates the synthesized speed control target value V3 based on the first speed control target value V1 and the second speed control target value V2 (S15).

Then, the drive control unit 40 computes the position deviation P2, which is the difference between the current rotational position of the motor M and the position control target value P1 generated by the model following control unit 10 (S2). Further, the drive control unit 40 outputs the speed command V4 based on the position deviation P2 (S3).

Furthermore, the drive control unit 40 computes the speed deviation V5, which is the difference between a current rotational speed based on a change in the current rotational position acquired in S1 and the corrected target speed obtained by correcting the synthesized speed control target value V3 generated in S15 by the speed command V4 output in S3 (S4). Further, the drive control unit 40 outputs the torque command T4 based on the speed deviation V5 (S5). Furthermore, the drive control unit 40 generates the torque command correction value T5 by correcting the synthesized torque control target value T3 generated in S15 by the torque command T4 output in S5 (S6). Then, the drive control unit 40 inputs a drive current based on the torque command correction value T5 to the motor M (S7). In the motor control apparatus 1, the processing described above is repeated each time an input position command value is received from the higher-level control apparatus 100.

### SUMMARY

In the motor control apparatus 1 according to the present embodiment, a control target value generated by the model following control unit 10 is corrected using a control target value generated by the additional feedforward control unit 20, which may prevent issues such as overshoot and residual position deviations that have been challenges in conventional model following control. In particular, concerning viscous friction occurring in the motor M, accurately modeling it may be difficult due to reasons such as use environmental dependencies. By employing additional feedforward control capable of compensating for viscous friction, the accuracy of the drive control of the motor M is improved. This particularly ensures stable response performance even when there is a rapid change in the operation of the motor M such as during acceleration or deceleration of the rotation of the motor M.

In addition, in the present embodiment, an example has been described in which the synthesis unit 30 includes the torque control target value synthesis unit 30A and the speed control target value synthesis unit 30B, but the synthesis unit 30 is not limited thereto and may include at least one of the torque control target value synthesis unit 30A and the speed control target value synthesis unit 30B.

Further, in the present embodiment, an example has been described in which the motor M is a rotary motor that rotates around a shaft serving as the center of rotation, but the motor M is not limited thereto and may be a linear motor. In this case, a control target value related to propulsion instead of torque may be used to control the driving of the linear motor.

### [Supplements]

For example, the motor control apparatus 1 may also have the following configuration.
(1) A motor control apparatus including:
a first computation unit that computes a first control target value by calculating an equation that models a device including a motor based on an input position command value;
a second computation unit that computes a second control target value based on differentiation of the input position command value;
a synthesis unit that generates a synthesized control target value based on the first control target value and the second control target value; and
a drive control unit that controls driving of the motor based on the synthesized control target value.
(2) The motor control apparatus described in (1), in which the synthesis unit generates the synthesized control target value by synthesizing the first control target value and the second control target value at a given ratio.
(3) The motor control apparatus described in (1) or (2), in which the first control target value includes a first torque control target value,
the second control target value includes a second torque control target value,
the synthesis unit generates a synthesized torque control target value serving as the synthesized control target value by synthesizing the first torque control target value and the second torque control target value at a given ratio, and
the drive control unit generates a torque command correction value to drive the motor based on the synthesized torque control target value.
(4) The motor control apparatus described in (3), in which the second computation unit computes the second torque control target value based on a viscous friction compensation value calculated by multiplying a second-order derivative of the input position command value and a first-order derivative of the input position command value by a predetermined viscous friction coefficient.
(5) The motor control apparatus described in any one of (1) to (4), in which the first control target value includes a first speed control target value,
the second control target value includes a second speed control target value,
the synthesis unit generates a synthesized speed control target value by synthesizing the first speed control target value and the second speed control target value at a given ratio, and
the drive control unit controls driving of the motor based on the synthesized speed control target value.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A motor control apparatus comprising:
first computation circuitry configured to compute a first control target value by calculating an equation that models a device including a motor based on an input position command value;
second computation circuitry configured to compute a second control target value based on differentiation of the input position command value;
synthesis circuitry configured to generate a synthesized control target value based on the first control target value and the second control target value; and
drive control circuitry configured to control driving of the motor based on the synthesized control target value.

2. The motor control apparatus according to claim 1, wherein the synthesis circuitry generate the synthesized control target value by synthesizing the first control target value and the second control target value at a given ratio.

3. The motor control apparatus according to claim 1, wherein the first control target value includes a first torque control target value,
the second control target value includes a second torque control target value,
the synthesis circuitry generate a synthesized torque control target value serving as the synthesized control target value by synthesizing the first torque control target value and the second torque control target value at a given ratio, and
the drive control circuitry generate a torque command correction value to drive the motor based on the synthesized torque control target value.

4. The motor control apparatus according to claim 3, wherein the second computation circuitry computes the second torque control target value based on a viscous friction compensation value calculated by multiplying a second-order derivative of the input position command value and a first-order derivative of the input position command value by a predetermined viscous friction coefficient.

5. The motor control apparatus according to claim 1, wherein the first control target value includes a first speed control target value,
the second control target value includes a second speed control target value,
the synthesis circuitry generate a synthesized speed control target value by synthesizing the first speed control target value and the second speed control target value at a given ratio, and
the drive control circuitry control driving of the motor based on the synthesized speed control target value.

6. A motor control method comprising:
computing a first control target value by calculating an equation that models a device including a motor based on an input position command value;
computing a second control target value based on differentiation of the input position command value;
generating a synthesized control target value based on the first control target value and the second control target value; and
controlling driving of the motor based on the synthesized control target value.

7. A non-transitory computer-readable storage medium having stored therein a program that causes a computer to execute a process including:
computing a first control target value by calculating an equation that models a device including a motor based on an input position command value;
computing a second control target value based on differentiation of the input position command value;
generating a synthesized control target value based on the first control target value and the second control target value; and
controlling driving of the motor based on the synthesized control target value.
